(19) United States
(12) Patent Application Publication
(10) Pub. No.: US 2013/0117071 A1
(43) Pub. Date: May 9, 2013

(54) TECHNIQUES FOR PROVIDING PERCEIVED QUALITY METRIC ANALYSIS

(71) Applicant: Stanley Kwon, San Francisco, CA (US)

(72) Inventor: Stanley Kwon, San Francisco, CA (US)

(73) Assignee: CBS INTERACTIVE INC., San Francisco, CA (US)

(21) Appl. No.: 13/292,878

(22) Filed: Nov. 9, 2011

(51) Int. Cl. G06Q 30/02

(52) U.S. Cl. 705/7.32

(57) ABSTRACT

Various embodiments for providing perceived quality metrics and analysis for products and content prior to sale are described. Embodiments may include surveying potential consumers about of what future products they are aware. For any product of which the survey responder is aware, the survey may poll the responder to rate their perception of the quality of those products. The ratings for any particular product may be aggregated, for example, by averaging to produce a quality metric. The survey may be administered on a periodic basis, for example, monthly or bi-weekly, and a change in the value of the quality metric over time for a product may provide valuable information to marketers and product developers. Other embodiments are described and claimed.

### BACKGROUND

Product and content vendors, and their marketers, can measure how aware potential consumers are of a product that is not yet available. However, awareness does not translate into intent to purchase. A consumer's intent to purchase a product may be related to the consumer's perception of the quality and/or value of the product. While it is possible to measure consumers' perception of the product quality after a product has been purchased and/or used, typically via ratings and reviews, measuring consumers' perceptions of quality for a product prior to availability may be difficult, and methods to do so are lacking in the current marketing landscape. Accordingly, there may be a need for an improved apparatus and methods for measuring perceived quality prior to product availability.

### BRIEF DESCRIPTION OF THE DRAWINGS

FIG. 1 illustrates a first system for providing perceived quality metric analysis in accordance with one or more embodiments.

FIG. 2 illustrates a second system for providing perceived quality metric analysis in accordance with one or more embodiments

FIG. 3 illustrates a block diagram of an example of a perceived quality metric application in accordance with one or more embodiments.

FIG. 4 illustrates an example of a perceived quality metric survey in accordance with one or more embodiments.

FIG. 5 illustrates an example of a graph of perceived quality metric values over time in accordance with one or more embodiments.

FIG. 6 illustrates an example of a user interface.

FIG. 7 illustrates a logic flow in accordance with one or more embodiments.

FIG. 8 illustrates a computing architecture in accordance with one or more embodiments.

FIG. 9 illustrates an embodiment of a communications architecture.

### DETAILED DESCRIPTION

Currently, marketers have a variety of metrics that allow them to measure consumer awareness of the products being marketed. These metrics can inform the marketers of what percentage of a target audience is being reached through marketing efforts and other information. However, awareness does not necessarily translate to an intent to purchase. Even where a consumer may indicate that they definitely intend to purchase a product or service, that intent does not reflect when they plan to purchase, at what price they plan to purchase, and what their perception of the quality of the product or service is.

Perceived quality may be difficult to determine objectively, in part because it is a subjective perception and also because judgments about what is important to consumers are involved. Perceived quality may be an intangible, overall feeling about a brand, and therefore it is a challenge to quantify and track over time. An aggregated quality score from some form of scoring system, or quality scores provided by professional reviewers, may be useful and somewhat objective, but these types of scores must make judgments or assumptions about the relative importance of various features of the product. These judgments or assumptions of relative importance may not match those of the actual consumer. Further, the timing of the release of professional reviews may make it difficult for marketers to gauge quality perceived by consumers from marketing efforts. Professional reviews are often not released until the product is released, which makes it difficult to use professional reviews as a metric in pre-release marketing planning.

Accordingly, various embodiments are directed to techniques for providing enhanced perceived quality metrics and analysis for products, services and content prior to sale. Embodiments may include providing different electronic surveying tools to survey potential consumers about future products (or services) of which they are currently aware. For any product of which the survey responder is aware, the survey may poll the responder to rate their perception of the quality of those products. The responder ratings for any particular product (or service) may be automatically aggregated using a scoring algorithm to produce a quality metric. The survey may be administered on a periodic basis, for example, monthly or bi-weekly, and a change in the value of the quality metric over time for a product may provide valuable information to marketers and product developers.

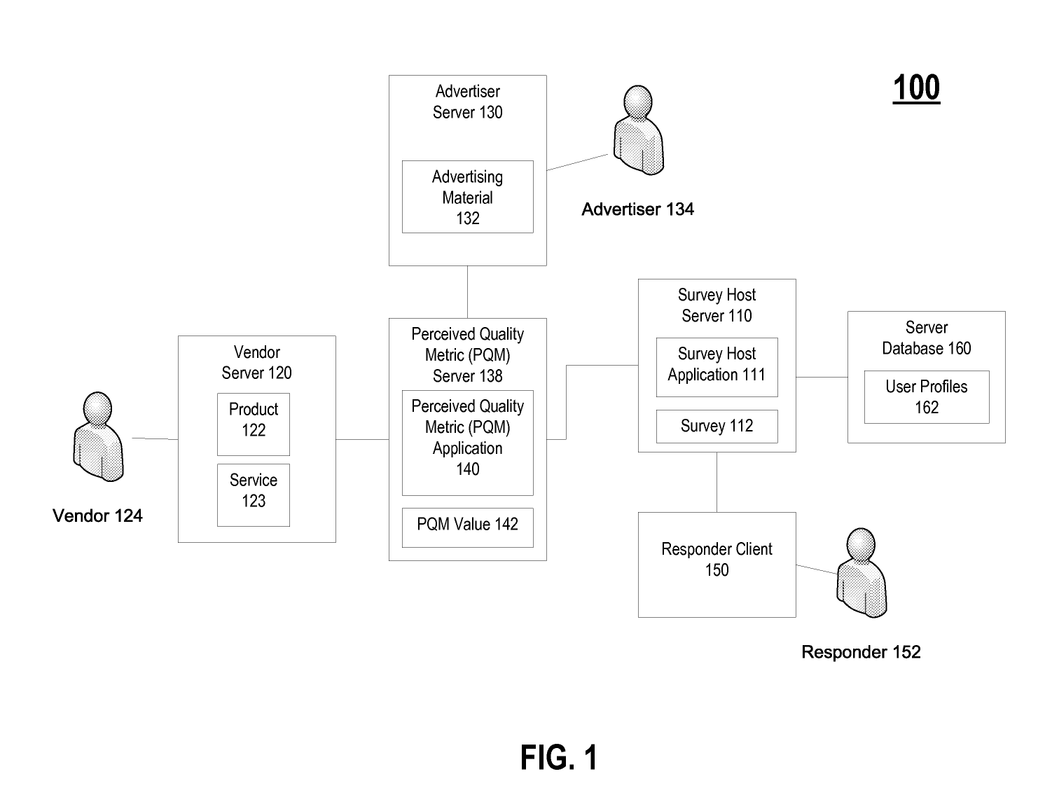

FIG. 1 illustrates a survey system 100 arranged to implement electronic perceived quality metrics and analysis tools for products, services and multimedia content. In one embodiment, the perceived quality metrics and analysis tools may be used prior to sale or public release of a product or service. In one embodiment, the perceived quality metrics and analysis tools may be used after sale or public release of a product or service, and may be used to refine or enhance conventional post-sale perceived quality techniques.

In one embodiment, for example, the survey system 100 may comprise a computer-implemented system having multiple components, such as a survey host server 110, a vendor server 120, an advertiser server 130, a perceived quality metric (PQM) application 140, and a responder client 150. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the survey system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the survey system 100 as shown in FIG. 1 has a limited number of elements in a certain topology, it may be appreciated that the survey system 100 may include more or less elements in alternate topologies as desired for a given implementation.

The computing entities or devices of survey system 100 may be communicatively coupled via a network, which may be implemented via various types of communications media, including wired or wireless communications media. The network may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The computing entities or devices of survey system 100 may include various types of standard communication elements designed to be interoperable with the network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between computing entities or devices of survey system 100 can be in the form of a data packet adapted to be transmitted between two or more computer processes. The data packet may include a cookie and/or associated contextual information, for example.

In an embodiment, survey system 100 may include survey host server 110 comprising a survey host application 111. Survey host server 110 may store survey questions about perceived quality in server database 160. Server database 160 may be data organized in one or more files and stored on one or more data storage devices. Server database 160 may be a component of survey host server 110 or of PQM application 140.

Survey host application 111 may comprise programming instructions that, when executing by processing logic or processing circuitry, causes an electronic device such as survey host server 110 to manage and administer surveys 112 to potential consumers. Survey host application 111 may automatically or programmatically select survey questions from server database 160 to generate surveys 112. Additionally or alternatively, survey host application 111 may retrieve pre-generated surveys 112 stored in by server database 160. Surveys 112 may each comprise a series of questions presented in electronic form as part of one or more web pages via a web browser (e.g. a web form). Examples of suitable web browsers may include, without limitation, Internet Explorer® by Microsoft® Corp., Safari® by Apple Inc., or Chrome® by Google®, among others. Surveys 112 may be presented from hypertext markup language (HTML) coded pages, extensible markup language (XML) coded pages, JAVA applets, plain text, and so forth, or a combination thereof. Surveys 112 may include graphical user interface (GUI) elements arranged to receive responses from potential consumers to the survey questions. A potential consumer responding to a survey is represented in FIG. 1 as a responder 152. Survey host server 110 may store the survey results in server database 160 for further analysis. In an embodiment, survey host application 111 may be a stand-alone application implemented on survey host server 110. In an embodiment, survey host application 111 may be implemented as a component of vendor server 120 or of advertiser 130.

Survey host application 111 may create and store user profiles 162 in server database 160. User profiles 162 may have information about responders 152. The stored information may include demographic information, such as age, gender, income bracket, occupation, and so forth. The results from one responder 152 of a survey 112 may be linked or associated with the stored information in a corresponding user profile 162, for example, to assist in analysis of survey results by demographic group. In an embodiment, the stored information may be anonymous. In another embodiment, the stored information may include identifying information about a responder 152, such as a user name, a user address, a user telephone number, a client identifier, a client internet protocol (IP) address, an assigned anonymous unique identifier, or a unique user name and password. The stored information may further include information about previous activity of a responder 152 at websites (e.g., a browser history) in cooperation with survey host server 110, such as items purchased, content categories viewed, messages posted, frequency of visits, and so forth.

Survey host application 111 may provide a survey 112 periodically up to a release date for a product, for example, once a month, every two weeks, or after each time a new advertising material 132 for a product 122 or a service 123 is made public. The survey results of one or more surveys 112 may be stored for each administration for time series analysis.

In an embodiment, survey system 100 may include one or more vendor servers 120. Vendor server 120 may comprise a server arranged for presenting an electronic storefront capable of executing ecommerce transactions and owned by a vendor 124. A vendor 124 may comprise any entity that is selling a product 122 or a service 123 about which perceived quality metrics are to be measured. In various embodiments, a product 122 may include any type of consumer product, for example, a game, a movie, a book, an audio recording, a television program, a video recording, an electronic device, a computer peripheral, a personal care product, an article of clothing, sports equipment, a service, a food item, a beverage, and any other consumer product. In various embodiments, a service 123 may include any type of consumer services, for example, a web service, an application service, a communications service, a social networking service, a gaming service, and any other electronically delivered service. The embodiments are not limited to these examples.

In an embodiment, vendor 124 may sell products 122 or services 123 through an online storefront, a physical retail store, or both. Vendor 124 may provide surveys 112 to survey host server 110 to administer, and may receive the results with vendor server 120. In an embodiment, vendor server 120 may receive a perceived quality metric (PQM) 142 from PQM application 140 for product 122. Vendor 124 may include entities that develop and produce products or services, and/or entities that sell products or services developed by other vendors. In an embodiment, survey host server 110 may be a component of, and hosted from, an electronic device controlled by vendor 124, e.g., vendor server 120.

In an embodiment, survey system 100 may include one or more advertiser servers 130 arranged for serving advertisements on behalf of one or more advertisers 134. An advertiser 134 may be any entity that generates advertising material 132 to advertise product 122 to be sold by vendor 124. Advertiser server 130 may comprise electronic devices on which survey questions can be generated, survey results received, and advertising materials produced and distributed. In an embodiment, advertiser server 130 may be owned by vendor 124, e.g. as an internal marketing department for a business or enterprise. Advertiser server 130 may be a component of vendor server 120, or communicatively coupled to vendor server 120. In an embodiment, advertiser 134 may be a third-party entity producing advertising material 132 on behalf of vendor 124.

In an embodiment, survey system 100 may include a perceived quality metric (PQM) server 138 hosting a perceived quality metric (PQM) application 140. PQM application 140 may comprise programming instructions that, when executing by processing logic or processing circuitry, causes an electronic device to receive survey results from survey host server 110. PQM application 140 may analyze the survey results to generate a perceived quality metric for a product 122.

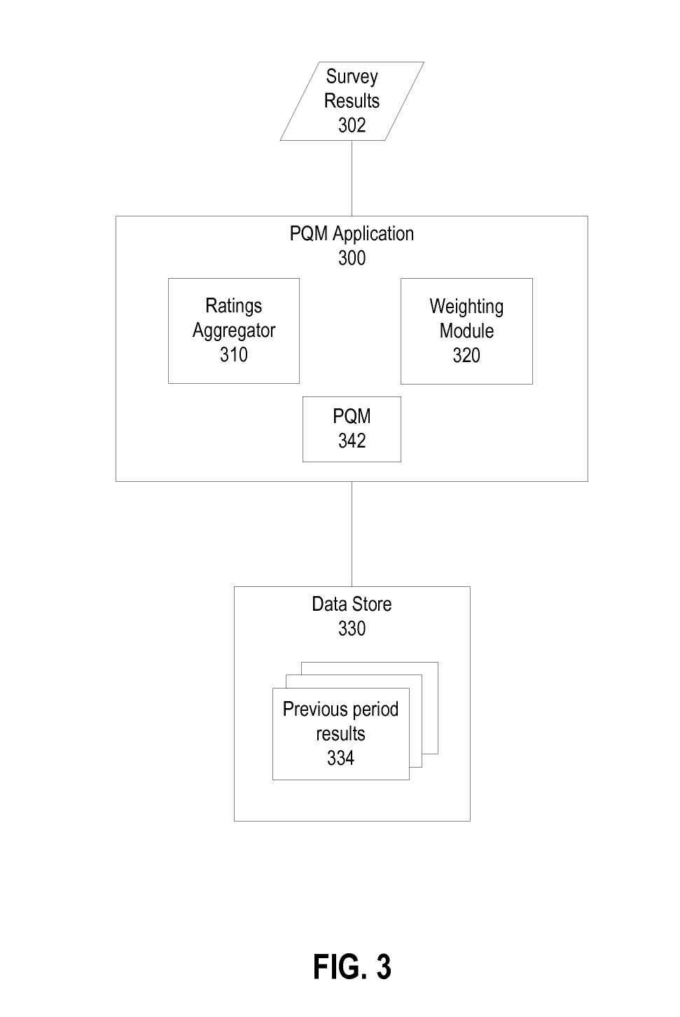

Additionally or alternatively, PQM application 140 may be a component of survey host server 110. In an embodiment, PQM application 140 may be a component of vendor server 120. In an embodiment, PQM application 140 may be a component of advertiser server 130. In an embodiment, PQM application 140 may be operative on an independent device, such as a server controlled by an entity independent from vendor 120 and advertiser 130, in communication with survey host server 110, and vendor server 120 and/or advertiser server 130. An embodiment of PQM application 140 is described further with respect to FIG. 3.

Responder client 150 may be a wired or wireless computing device operating a browser, application viewer or other application program suitable for receiving and displaying a survey 112 administered by survey host server 110. Responder client 150 may receive and respond to control directives from a responder 152 via a suitable GUI and various input/output (I/O) devices, such asinput from an input device that causes the browser to connect to a specific website, receive survey answers, fill out a form, follow a hyperlink, and so forth.

Responder client 150 may receive and store information about online activity of a responder 152. For example, responder client 150 may store a browser history for a browser application operating on responder client 150. The browser history may maintain a list of all of the website addresses or uniform resource locators (URLs) visited by the responder 152 within a certain time period. Responder client 150 may also receive and store cookie files from websites visited, including from survey host server 110. The cookie files may record actions taken at a particular website, including links followed, search strings entered, a product purchased, and/or metadata associated with the web pages visited at the website. Responder client 150 may also keep a record of input commands received from a responder 152, output presented on a display for the responder 152, biometric information about the responder 152, sensor information for various sensors implemented by the responder client 150 (e.g., proximity sensors, motion sensors, environmental sensors, and so forth), applications executing on the responder client 150, state information for the responder client 150, and any other information that may assist in identifying the responder 152 and/or categorizing the responder 152 in one or more demographic groups. The embodiments are not limited to these examples.

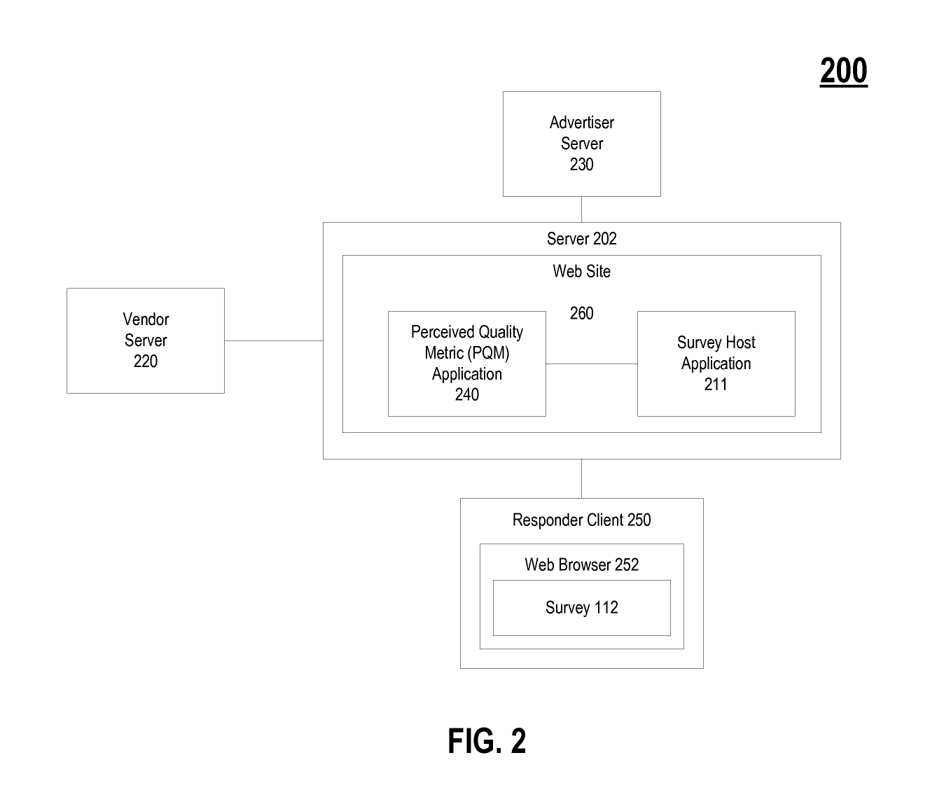

FIG. 2 illustrates a system 200 to provide perceived quality metric analysis. System 200 may be similar to survey system 100 with the following differences. System 200 may include a server 202 arranged to implement a web site 260. In some cases, web site 260 may be operated by an entity, such as a corporation, association, or individual, and hosted primarily from one network address. A web site, such as web site 260, may serve various types of content as, for example, a news site, an online storefront, a consumer product information site, a blog, a social networking site, a gaming site, a user forum site, an entertainment site, a sports site, a professional sports site, a college sports site, a high school sports site, a financial services site, a financial products site, and other websites aggregating a certain type or genre of information. The embodiments are not limited to these examples.

Web site 260 may include survey host application 211 and PQM application 240 as components. Survey host application 211 and PQM application 240 may be representative of the survey host application 111 and the PQM application 140, respectively, as described with reference to FIG. 1. For example, if web site 260 is an online storefront, web site 260 may generate one or more web pages to present one or more surveys 112 about one or more products 122 that may be prospectively sold on web site 260 in the future may be presented to users viewing web site 260 via a web browser 252 implemented by responder client 250. If web site 260 is a consumer product information site, for example, surveys 112 about future consumer products may be presented. If web site 260 is a gaming site, for example, surveys 112 about a future game may be presented. The embodiments are not limited to these examples.

Web site 260 may provide the perceived quality metric from PQM application 240 to vendors 220 and/or advertisers 230 as a value-added service. For example, if a vendor 220 is planning on selling a product 122 at web site 260 in the future, vendor 220 may use advertiser 230 to create “buzz” or awareness of the product by generating advertising materials 132 about the product 122. The perceived quality metric returned from PQM application 240 may provide feedback to the vendor 124 and/or advertiser 134 via respective servers 220, 230 about both awareness and the perceived quality of the product from potential consumers. In an embodiment, a survey 122 may be administered and the perceived quality metric measured before and after a new set of advertising materials 132 is made public, providing feedback about the effectiveness of the advertising materials 132. The perceived quality metric 142 may also be compared or analyzed in conjunction with pre-order information for a product 122.

FIG. 3 illustrates an embodiment of a perceived quality metric (PQM) application 300. PQM application 300 may be a representative embodiment of PQM application 140 or 240. PQM application 300 may include one or more functional components, such as a ratings aggregator 310 and a weighting module 320. PQM application 300 may be communicatively coupled to a data store 330. PQM application 300 may be a component of a survey host, such as survey host application 111 or 211, or PQM application 300 may be a stand-alone application operating separately from a survey host.

Ratings aggregator 310 may receive survey results 302 of one or more responders 152 from survey host server 110. The survey results 302 may include all of the perceived quality rating values from responders 152 about one or more products 122. The survey results 302 may also include demographic information about responders 152 via the corresponding user profiles 162. The ratings may include a range of values, e.g. from 1 to 10, 0 to 5, 1 to 100, and so forth.

Ratings aggregator 310 may perform statistical or analytical operations on the ratings data to generate a perceived quality metric (PQM) 342. For example, ratings aggregator 310 may generate PQM value 342 from the average of the ratings over the entire sample of survey responders for a product. Ratings aggregator 310 may generate PQM value 342 from the median value of the ratings over the entire sample of survey responders for a product. Ratings aggregator 310 may generate PQM value 342 from a weighted average value of the ratings, in conjunction with weighting module 320, over the entire sample of survey responders for a product.

Ratings aggregator 310 may divide the ratings data into segments according to the demographic data. For example, the ratings data may be divided by gender, median age, household income, education level, and so forth. Ratings aggregator 310 may average the ratings within one demographic group to generate a PQM for the product within the specific demographic group. Ratings aggregator 310 may further compare the PQMs 342 from different demographic groups for one product or service. For example, ratings aggregator 310 may determine that the product has a PQM value 342 of 80 (out of 100) with males between 18 and 30, and a PQM value 342 of 40 with males between 50 and 65. This information may be used by advertisers 134, for example, to increase marketing efforts targeted to males between 18 and 30, and/or to change a marketing strategy towards males between 50 and 65.

Ratings aggregator 310 may generate PQM value 342 by first determining which rating value was selected by the highest percentage responders, and using that rating value as the PQM value 342. For example, if 40% of responders rated a product with a score of 8 out of 10, while 30% rated the product as a score of 9 out of 10, 20% rated the product as a score of 6 out of 10, and 10% rated the product as a score of 7 out of 10, ratings aggregator 310 may select the 8 value as the PQM value 342.

In another embodiment, ratings aggregator 310 may convert or normalize a raw value of a PQM value 342 in one scale, e.g. 1 to 10, to a different scale, e.g. 1-100. A PQM value 342 may also be mapped into a category, for example, scores of 1-3 may be mapped to a “low” category, 4-6 may be mapped to an “average” category, and 7-10 may be mapped to a “great” category.

The ratings data may be stored in raw form, in aggregated form, or both, as previous period results 334 on data store 330. Previous period results 334 may be used to compare the perceived quality metric values over time. A period may reflect the time between administrations of the survey for a particular product. A period between a first administration and a second administration, and a period between the second administration and a third administration, may or may not be of the same duration.

Weighting module 320 may weight the ratings data in various ways for use by ratings aggregator 310. For example, weighting module 320 may weight the ratings data according to demographic ratios to homogenize the data so that a current perceived quality metric may be compared more accurately to previous period results 334. For example, if one administration of a survey 112 had a 59/41 percentage ratio of male to female responders 152, and a second administration of the survey 112 had a 64/36 percentage ratio of male to female responders 152, weighting module 320 may weight or normalize the data of one or both administrations of the survey 112 to enable comparison.

Weighting module 320 may also apply weights to ratings from different demographic groups within one responder sample, for example, to emphasize ratings from a target audience. For example, if a product 122 is an item of sporting equipment, e.g. a golf club, weighting module 320 may assign a heavier weight, in an averaging calculation, to the ratings from identified experienced golfers compared to ratings from novice golfers, or basketball players.

Data store 330 may be a component, such as a computer-readable storage medium, of an electronic device on which PQM application 300 operates. Data store 330 may alternatively be a component of a different device, and accessible to PQM application 300 for reading and writing data.

The components of PQM application 300 may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Examples of connections may include parallel interfaces, serial interfaces, and bus interfaces.

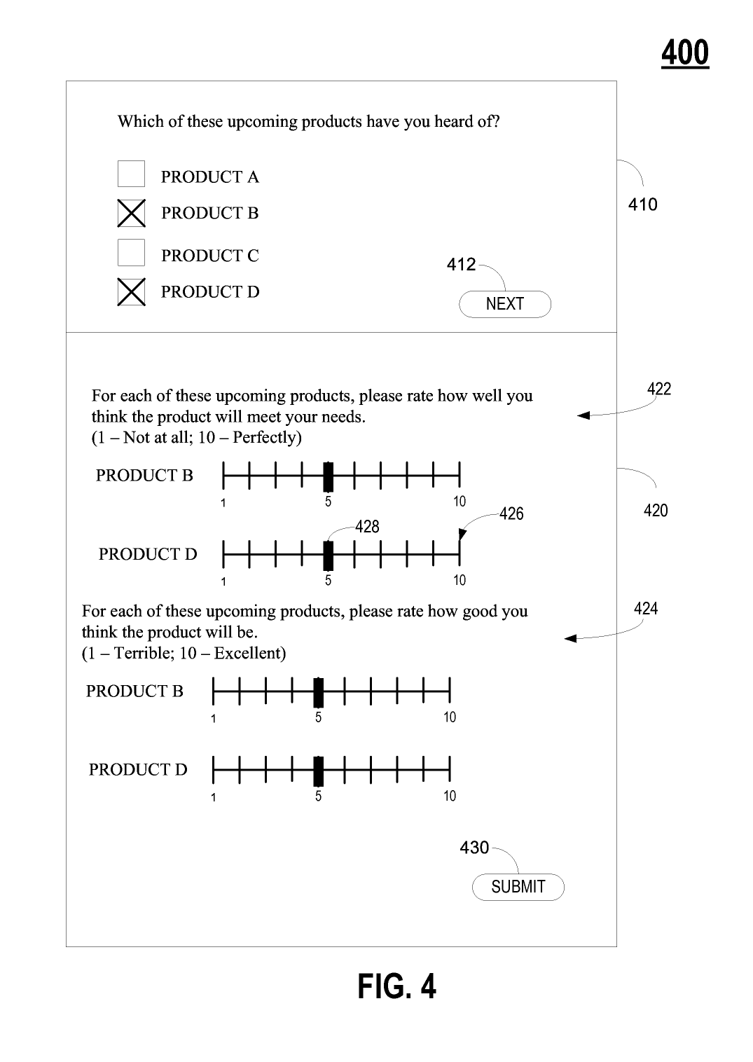

FIG. 4 illustrates an embodiment of a perceived quality metric (PQM) survey 400. PQM survey 400 may be a representative embodiment of a survey 112. PQM survey 400 may comprise an exemplary GUI view of a web page that may be received from survey host applications 111, 211 of survey host server 110 and rendered for presentation to a responder 152, for example, in a web browser application operating on responder client 150. Additionally or alternatively, PQM survey 400 may be rendered by a thin-client application specifically arranged for viewing PQM surveys 400 generated by survey host applications 111, 211.

PQM survey 400 may have an awareness pane 410. Awareness pane 410 may ask the responder 152 to select or otherwise indicate, using responder client 150, which products, from a set of products 122, the responder 152 is currently aware of. For example, in awareness pane 410, PQM survey 400 lists four products A-D, and asks the responder 152 to indicate with checkboxes which product the responder 152 is currently aware of. In the illustrated example, the responder 152 has selected Product B and Product D. Other ways of presenting the options may be used without limitation.

In an embodiment, when the responder 152 has finished selecting products A-D, selecting the next button 412 may open ratings pane 420. In an embodiment, if only one product is being surveyed, awareness pane 410 may be omitted. Alternatively, the question in awareness pane 410 may instead be a question of the form “Are you aware of Product A?”, with “yes” and “no” as answer choices. The embodiments are not limited to these examples.

Ratings pane 420 may be presented once a responder 152 has provided a selection of one or more products that they are aware of. Ratings pane 420 may ask one or more questions to elicit a rating from the responder about their perception of product quality for each product for which the responder has indicated awareness. For example, ratings pane 420 may ask question 422, question 424, or both. For each product, a means for indicating a rating of the quality of the product may be provided. For example, a number line 426 may be presented that represents the range of possible ratings. A slider 428 may be positioned by the responder on a number to indicate that number as a rating. Other examples may include selecting one or more stars, thumbs-up icons, or other graphical representations of a rating; selecting numbers from a menu; selecting a check-box or other on/off toggle user interface element to indicate a rating choice, and so forth. The embodiments are not limited to these examples. When the responder is finished rating products, selecting the submit button 430 may submit the answers to survey host server 110.

In an embodiment, instead of having an awareness question and a separate ratings question, a survey may provide the awareness question as a selection option with the rating options to allow the responder to indicate “I have not heard of this product” instead of a rating.

In an embodiment, a responder may be asked to provide demographic information before or after the administration of the survey, or as part of the survey. Survey host application 111 (or 211) may couple the demographic information with the answers submitted from a responder for later analysis. In an embodiment, if a responder 152 is a registered user of a web site that hosts or is otherwise in communication with survey host server 110, such as a social networking service (SNS) server, demographic information about the registered user may be stored and provided to survey host server 110.

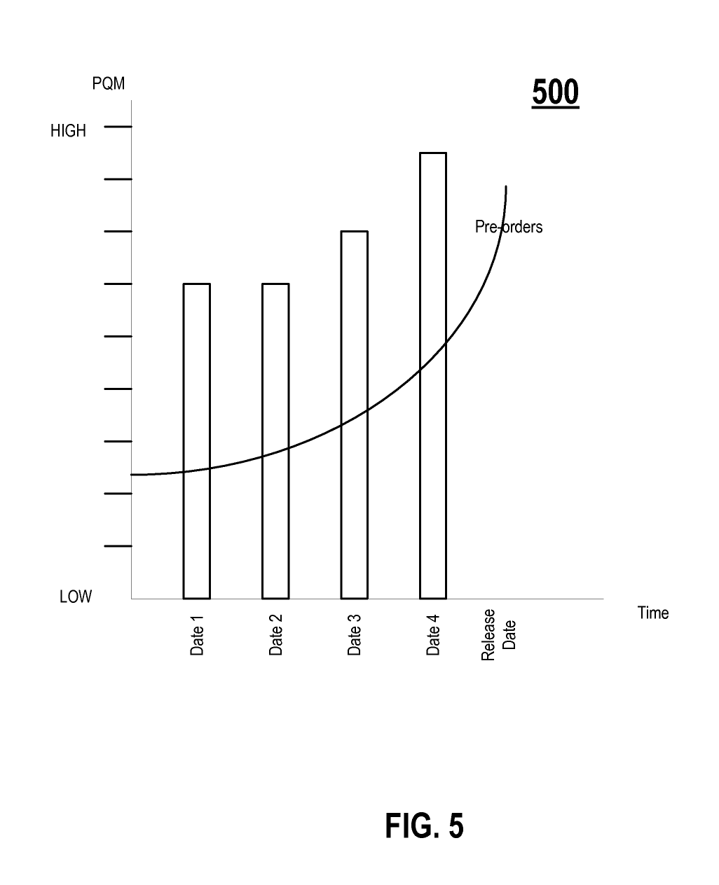

FIG. 5 illustrates a bar graph 500 that shows an example of a perceived quality metric value changing over time, as determined from four surveys. The x-axis represents time, and the y-axis represents the perceived quality metric (PQM) 342 for a product. Graph 500 may show the PQM value 342 over an entire sample, or may reflect PQM value 342 within a specified demographic group, e.g. males between the ages of 18 and 30.

In the illustrated example, the PQM value 342 does not change between the survey 112 administered on Date 1 and the survey 112 administered on Date 2. The PQM value 342 may reflect the quality and/or effectiveness of advertising materials 132. Advertising materials 132 may include various advertising assets, for example, print ads, previews, trailers, television advertisements, demonstrations, and so forth. The PQM value 342 may be used to evaluate the effect of an advertising asset on the perceived quality of the product. For example, a marketer may view the PQM value 342 from the first two surveys 112 and interpret the lack of positive change in the PQM value 342 to mean that the advertising assets currently in use are not sufficient to improve quality perception. The marketer may change the advertising material 132 served by advertiser server 130 and deploy the changes after Date 2. Graph 500 shows that the PQM for the product improves between Date 2 and the next survey 112 on Date 3. The marketer may interpret the improvement in PQM value 342 to mean that the changed advertising assets are more effective at improving perceived quality.

In an embodiment, PQM data may be used in conjunction with other data. For example, graph 500 shows a pre-order line that reflects the number or growth in pre-orders of the product. The number of pre-orders may in some cases be correlated to the PQM value 342.

In an embodiment, the PQM value 342 may be presented on a web site as a trend value. For example, in an online storefront, pre-release products having higher PQM value 342 may be displayed and called out as high quality products. Historical PQM value 342 for released products may be displayed in conjunction with post-release actual quality measures to provide a quality context for the PQM value 342 of a pre-release product from the same developer.

The PQM value 342 may be used to increase advertising revenue. For example, a web page may display information about a product, e.g. an electronic game, or service. The web page may also display advertisements for other products and services. When the electronic game has a high PQM value 342 compared to a second electronic game, the advertising rate for the first electronic game's page may be higher than those for web page for the second electronic game.

The PQM value 342 may be used by an advertising server, e.g. advertising server 130, 230, to select advertisements to serve to a web page for display. For example, advertisements for a product or service with a high PQM value 342 may be selected more frequently for serving compared to products or services with lower PQM values. In order to improve quality perception for a low-rated product or service, advertisers, e.g. advertiser 134, may serve advertisements for the low-rated product or service more frequently, at a higher rate, or may charge a premium to serve advertisements for the low-rated product or service on web pages for highly rated products or services.

In an embodiment, the survey system 100, 200 may select advertisements to serve intelligently according to information in the user profiles 162. For example, suppose a responder 152 having a user profile 162 has rated a book highly in a PQM survey 112. Advertisements for other books of the same genre, by the same author, and/or with high ratings from other responders having similar user profiles may be selected to display to that responder 152 in web browser 252.

In an embodiment, the survey system 100, 200 may compare user profiles 162 to identify responders 152 who are similar in demographic grouping, interests, and/or other factors captured in user profiles 162. The PQM survey 112 responses from similar responders may used to identify products or services that a responder may also be interested in. If a responder 152 indicated in a survey 112 that the responder was not aware of a particular product, and the user profile 162 data indicates that the product would be of interest to the responder 152, then advertisements for that product may be selected to server to that responder to increase the responder's awareness.

The PQM value 342 may be used in conjunction with social networking service (SNS) applications, or other consumer information, to provide suggestions to a potential consumer. For example, a suggestion such as “People like you who thought that Product A would be excellent also think Product B will be excellent” could be presented to the potential consumer. The “people like you” may reflect people who have made similar purchases, provided similar ratings and reviews on similar products, having indications of similar interests, and so forth.

The PQM value 342 may be used in setting or adjusting an initial sale price for a product. For example, a product with a higher PQM value 342 may be able to sell for a higher price at release than a similar product with a lower PQM value 342. The PQM value 342 may also be used as a factor in forecasting a sales volume, for example, in addition to actual pre-orders. A higher PQM 342 for a product 122 or a service 123 may correlate to higher sales post release.

Some types of products or services have a fixed price on release, regardless of perceived quality. Most electronic games, for example, are released for sale at a price determined more by platform than other factors. The PQM value 342 may be used to plan how long to keep the initial price before lowering the price. A game with a high PQM may maintain sales volume at the initial price for longer than a lower rated game. Movies released in theatres have their ticket prices set by the box office. The PQM values 342 may be used to plan how long to make the product available for sale, e.g. how long a movie will play in a theatre, or to plan how many showings to have in a day.

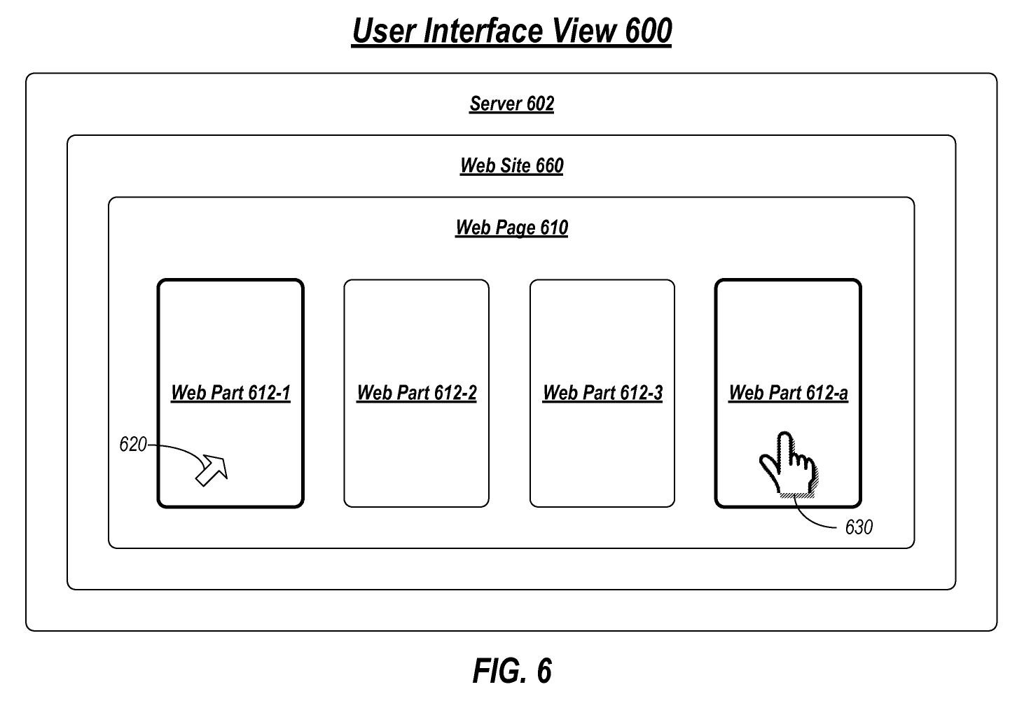

FIG. 6 illustrates an embodiment of a user interface view 600. The user interface view 600 illustrates an embodiment where server 602 hosts content on a web site 660, which is implemented as one or more web pages 610. Server 602 and web site 660 may be representative embodiments of server 202 and web site 260, respectively. The web page 610 may comprise, for example, a landing page or home page for the website. The web page 610 may include various user interface elements designated as web parts 612-a, with a representing any positive integer. A user may select various web parts 614-a using any number of input devices, such as by manipulating a pointer interface 620 or a gesture interface 630, for example.

In an embodiment, the PQM value 142 may be calculated automatically from on a user's browsing pattern and history, as captured, for example, in user profiles 162. The calculation of PQM value 142 from user browsing pattern and history may be in conjunction with survey 112 results, or instead of survey 112 results. In an embodiment, a PQM application, e.g. PQM application 240, or a survey host application, e.g. survey host application 211, may monitor a user, e.g. responder 152, while the user browses a web site, e.g. web site 660. Information gathered while monitoring a user may be stored in a user profile 162 for that user. The PQM application or survey host application may measure, for example, what content is viewed, for how long content is viewed, when a link to additional information about the content is followed, when the content is searched for, and so forth. In an embodiment, the PQM application may receive or read information about the user's browsing pattern and history from user profiles 162 instead of measuring the information directly.

Referring to FIG. 6, web site 660 may include a web page 610 that displays advertising content for a yet-to-be released product or service. For example, suppose web part 612-1 displays an advertisement for a product X, and web part 612-a displays an advertisement for a service Y. Suppose web part 612-1 includes a hyperlink that leads to another web page having information about product X. Suppose web part 612-a includes a video that can be played within web part 612-a when selected by an input device. Web part 612-2 may display information about a product or service that is currently available for purchase. Web part 612-3 may display information about the same product or service as web part 612-2, or may display other information, such as web site navigation links, viewer comments, a search interface, and so forth.

PQM application or survey host application may monitor some or all of the following with respect to web page 610: how long web page 610 is viewed before being navigated away from; whether pointer interface 620 or gesture interface 630 is placed within web part 612-1 or web part 612-a; for how long pointer interface 620 or a gesture interface 630 is placed within web part 612-1 or web part 612-a; whether the hyperlink in web part 612-1 is followed; whether the video in web part 612-a is viewed; what web page, if any, the user viewed before web page 610; and what web page, if any, the user navigates to after web page 610. The embodiments are not limited to these examples.

The information gathered from monitoring a user's actions at web page 610 may be combined with other user behavior events. For example, a browser history for the user may be examined to determine what web sites or pages the user views frequently, and the product or services that may be associated with those frequently viewed pages or sites. The products or services that the user has purchased online may be examined to determine what kinds of products or services are desirable for that user. Comments or reviews made by the user about a product or service may be examined for indications of positive or negative opinion about a product. Search strings entered in a search interface may be examined to determine what topics, products or services are of interest to the user. The embodiments are not limited to these examples.

The information gathered from the user behavior online may be statistically analyzed by PQM application 240 to generate the PQM value 142. For example, the user's behavior at web site 660 may be compared to the behavior of other users at web site 660. A user who spends more time viewing or interacting with advertising content may be interpreted as having a higher perception of quality of the advertised product or service. In an embodiment, a measure, e.g. number of times a linked was followed, amount of time spent viewing content, and so forth, may be divided in a score, which may be similar to a score from a survey 112. For example, suppose a user is in a top tenth percentile of amount of time spent viewing content about the no-yet-released product or service. The percentiles of that measure may be mapped to a PQM score. The top tenth percentile, for example, may be mapped to the highest possible PQM score, or to a category, e.g. “great”. Those scores may then be averaged over the all of users viewing the content of web page 610 or web site 660 to determine a PQM value 142. In an embodiment, the score determined from the user behavior may be included in the aggregation of ratings to determine a PQM value 142.

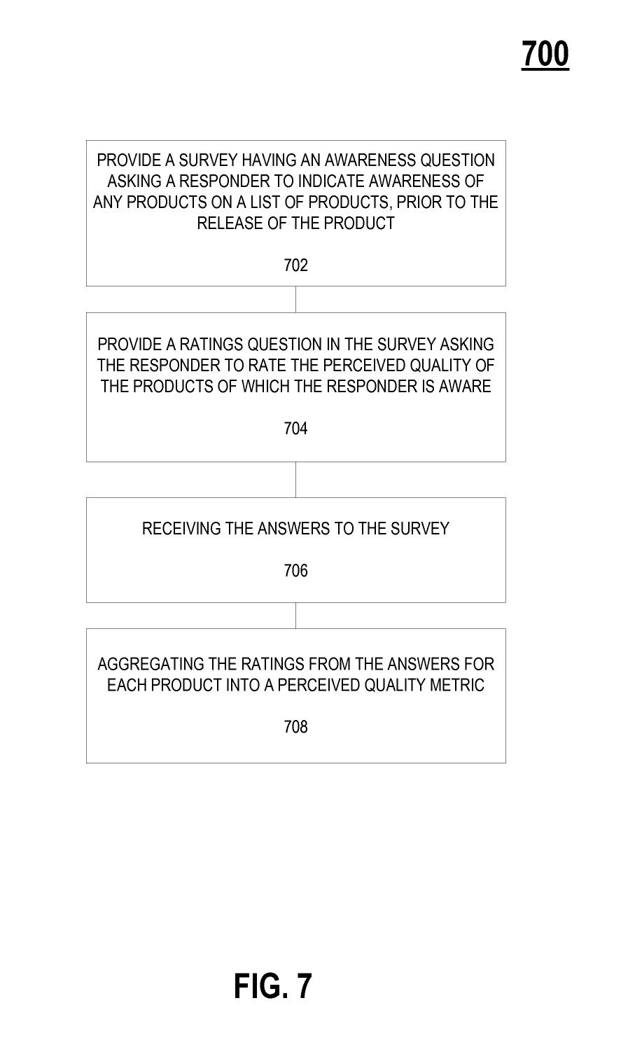

FIG. 7 illustrates a logic flow 700 in accordance with one or more embodiments. The logic flow 700 may be performed by various systems and/or devices and may be implemented as hardware, software, and/or any combination thereof, as desired for a given set of design parameters or performance constraints. For example, the logic flow 700 may be implemented by a logic device (e.g., processor) and/or logic (e.g., threading logic) comprising instructions, data, and/or code to be executed by a logic device. For purposes of illustration, and not limitation, the logic flow 700 is described with reference to FIGS. 1 and 3. The embodiments are not limited in this context.

In various embodiments, the logic flow 700 may provide a survey prior to the release of a product in block 702. For example, survey host application 111, 211 may execute programming logic that causes a web browser 252, a thin-client application, or other application to present, on a responder client 150, one or more questions for a survey 112. The survey 112 may include an awareness question to determine what products the responder 152 is aware of. The awareness question may ask the responder 152 to indicate which products from a list of products the responder 152 has heard of. The awareness question may ask the responder 152 to indicate awareness or not for a particular product.

In various embodiments, the logic flow 700 may provide a ratings question for each of the products of which the responder is aware, asking the responder to rate the perceived quality of the product in block 704. For example, a ratings question may ask the responder 152 to assign or select a value from a range of values that corresponds to the responder's perception of the product's quality.

In various embodiments, the logic flow 700 may receive the answers to the survey in block 706. For example, survey host application 111, 211 or PQM application 140 may receive the values selected by the responder 152 for each product 122. The answers may be coupled to demographic information about the responder 152.

In various embodiments, the logic flow 700 may aggregate the ratings from the answers for each product into a perceived quality metric in block 708. For example, ratings aggregator 310 may receive the ratings from the survey answers. Ratings aggregator 310 may calculate an average rating, for a particular product, from the entire sample of responders 152. Ratings aggregator 310 may divide the responders 152 into segments corresponding to various demographic groups, e.g. women having a household income between $50,000 and $70,000 a year, or men having a college degree. The ratings from a particular demographic group may be averaged for the product 122. Other methods of aggregation may be used. For example, ratings aggregator 310 may calculate the median value of the ratings. In an embodiment, the ratings from various demographic groups may be weighted with respect to each other. For example, ratings from a particular target demographic group may be given a heavier weight in an averaging calculation compared to a non-target demographic group. The embodiments are not limited to these examples.

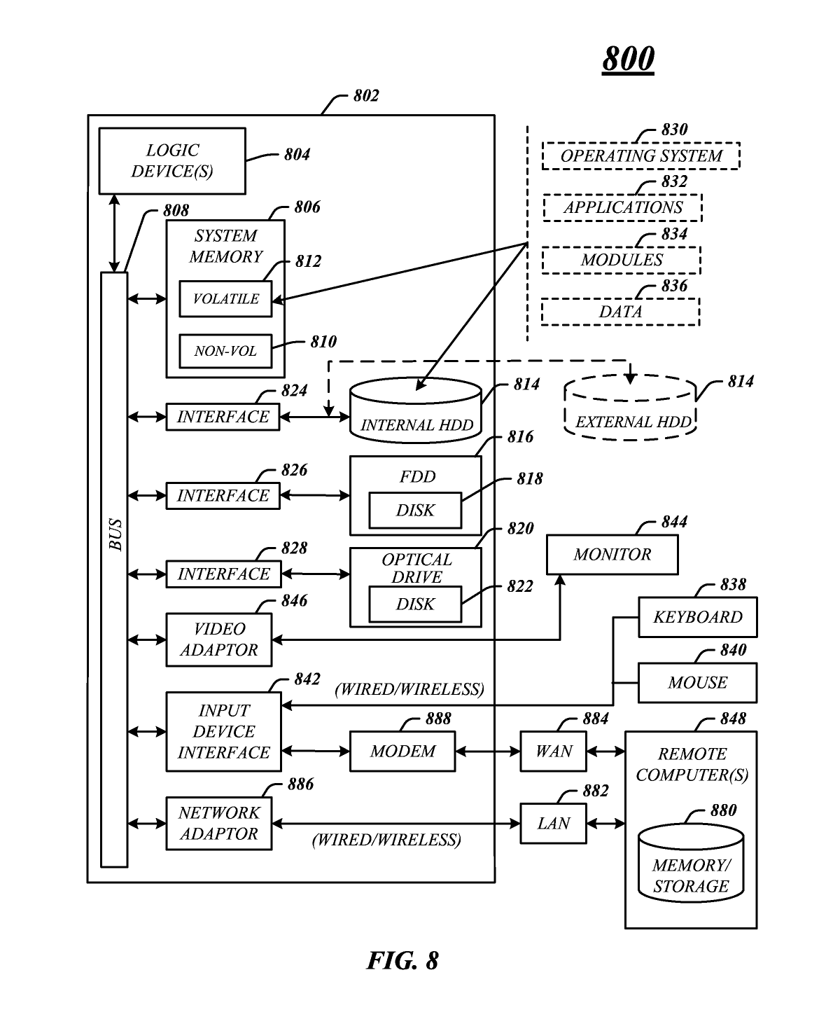

FIG. 8 illustrates a computer architecture in accordance with one or more embodiments, suitable for implementing various embodiments as previously described. The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises logic device(s) 804, a system memory 806 and a system bus 808. Examples of a logic device may include, without limitation, processing circuitry, such as a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 804. The system bus 808 provides an interface for system components including, but not limited to, the system memory 806 to the logic device(s) 804. The system bus 808 can be any of several types of bus structure that may further interconnect to a memory bus (with or without a memory controller), a peripheral bus, and a local bus using any of a variety of commercially available bus architectures.

The system memory 806 may include computer-readable storage media including various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may additionally include various types of computer-readable storage media, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. The one or more application programs 832, other program modules 834, and program data 836 can include, for example, PQM application 140, 240, 300, ratings aggregator 310 and weighting module 320.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the logic device(s) 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

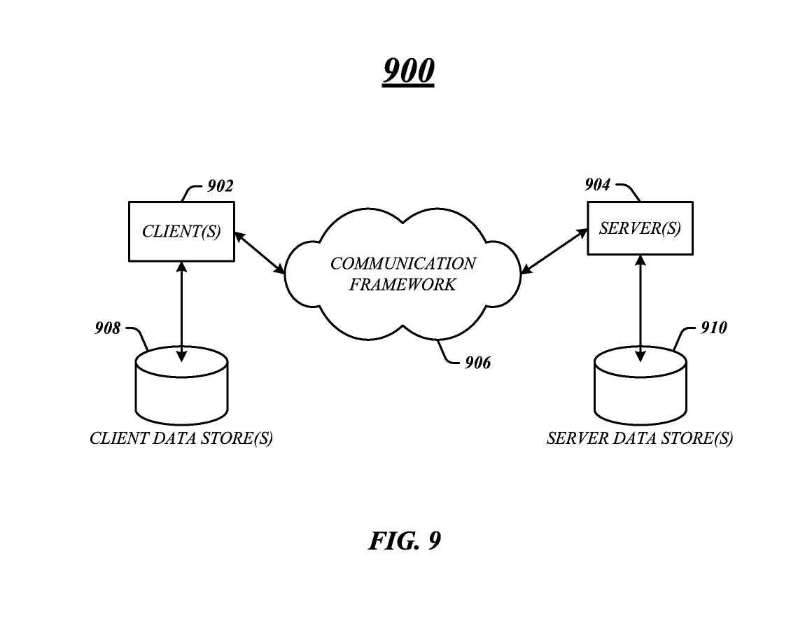

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the responder client 150, 250. The servers 904 may implement survey host server 110, vendor server 120, 220, advertiser server 130, 230, and server 202. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

References to “one embodiment” or “an embodiment” mean that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computer-implemented method comprising:
providing a survey comprised of a first question asking a responder to indicate awareness of a product and a second question asking the responder to rate the quality of the product when the responder is aware of the product, based on product information presented by a web site;
receiving the answers to the survey; and
aggregating the ratings, using processing circuitry, from the answers for each product into a perceived quality metric.

2. The method of claim 1, further comprising:
providing the survey periodically; and
weighting the answers for a period to homogenize a sample of responders for that period with respect to a sample of responders from a previous period.

3. The method of claim 1, further comprising:
providing the survey prior to the release of the product.

4. The method of claim 1, further comprising:
dividing the answers by demographic group; and
averaging the ratings within a demographic group.

5. The method of claim 1, further comprising:
evaluating an effect of an advertising asset on perceived quality using the perceived quality metric.

6. The method of claim 1, further comprising at least one of:
forecasting a sales volume using the perceived quality metric; and
setting an initial sale price for a product according to the perceived quality metric.

7. The method of claim 1, wherein a product comprises at least one of: a game, a movie, a book, an audio recording, a television program, an electronic device, a computer peripheral, a personal care product, an article of clothing, sports equipment, a service, a food item, and a beverage.

8. An apparatus comprising:
a logic device;
a data store to store survey information and survey results and communicatively coupled to the logic device;
a survey host operative on the logic device to:
provide a survey comprised of a rating question asking a responder to rate a perceived quality of a product prior to the release of the product;
receive the answers to the survey; and
store the answers to the survey in the data store.

9. The apparatus of claim 8, wherein the survey further comprises an awareness question asking the responder to indicate awareness of products from a selection of products, and a ratings question for each product from the selection of products for which the responder indicates awareness.

10. The apparatus of claim 8, further comprising a perceived quality metric (PQM) application operative on the logic device, operative to:
aggregate the ratings from the answers into a perceived quality metric for the product.

11. The apparatus of claim 10, the PQM application further operative to:
average the ratings from the answers over a sample of responders into a perceived quality metric for the product.

12. The apparatus of claim 8, the PQM application further operative to:
divide the answers by demographic group; and
aggregate the ratings within a demographic group.

13. The apparatus of claim 8, the survey host further operative to provide the survey periodically; and the PQM application further operative to weight the answers for a survey period to homogenize a sample of responders for that period with respect to a sample of responders from a previous survey period.

14. The apparatus of claim 8, wherein a product comprises at least one of: a game, a movie, a book, an audio recording, a television program, an electronic device, a computer peripheral, a personal care product, an article of clothing, sports equipment, a service, a food item, and a beverage.

15. A machine-readable storage medium comprising instructions that when executed cause a computing system to:
provide a survey comprised of an awareness question asking the responder to indicate awareness of products from a selection of products and a rating question asking a responder to rate a perceived quality of a product prior to the release of the product;
receive the answers to the survey; and
store the answers to the survey in a data store.

16. The storage medium of claim 15, further comprising instructions that when executed cause the computing system to aggregate the ratings from the answers into a perceived quality metric for the product.

17. The storage medium of claim 16, further comprising instructions that when executed cause the computing system to:
divide the answers by demographic group; and
aggregate the ratings within a demographic group.

18. The storage medium of claim 16, further comprising instructions that when executed cause the computing system to:
provide the survey a plurality of times;
homogenize a sample for a first survey with a sample from a second survey; and
display a perceived quality metric for the first survey compared to a perceived quality metric for the second survey.

19. The storage medium of claim 16, further comprising instructions that when executed cause the computing system to communicate a perceived quality metric for a product to at least one of an advertiser, a product developer, and a vendor.

20. The storage medium of claim 16, further comprising instructions that when executed cause the computing system to:
provide a perceived quality metric for a product for display on a web site.
